(19) United States
(12) Patent Application Publication
(10) Pub. No.: US 2011/0224330 A1
(43) Pub. Date: Sep. 15, 2011

(54) FIBERS COATED WITH NANOWIRES FOR REINFORCING COMPOSITES

(76) Inventors: Henry A. Sodano, Mesa, AZ (US); Gregory John Ehlert, Tempe, AZ (US)

(21) Appl. No.: 13/000,568

(22) PCT Filed: Jun. 26, 2009
(86) PCT No.: PCT/US09/48971

§ 371 Date: Dec. 21, 2010

Related U.S. Application Data
(60) Provisional application No. 61/076,113, filed on Jun. 26, 2008.

(51) Int. Cl. C08K 9/02; C08L 63/00; C08L 77/10; C08K 3/22; C08L 33/00; C08L 67/00; C08L 61/06; C08L 71/10; C08L 81/06; C08L 81/04; C08L 61/16; B82Y 30/00

(52) U.S. Cl. 523/442; 523/459; 525/423; 524/424; 525/183; 525/425; 525/429; 525/432; 525/420; 977/762; 977/753

(57) ABSTRACT

Fiber reinforced composites fabricated using a low-temperature, solution-based growth of nanowires such as ZnO nanowires on the surface of the reinforcing fibers such as carbon fibers and functionalized aramid fibers. The composites with nanowire interphase may have an enhanced fiber/matrix interface strength and a comparable in-plane strength, as compared to similar composites without such nanowire interphase.

### CROSS-REFERENCE TO RELATED APPLICATION

This patent document claims priority to U.S. Provisional Patent Application Ser. No. 61/076,113 to Henry A. Sodano, entitled “Fibers Coated with Nanowires for Reinforcing Composites,” and filed Jun. 26, 2008, the entire disclosure of which is incorporated herein by reference.

### TECHNICAL FIELD

This document relates to fiber composites.

### BACKGROUND

A fiber reinforced composite is an artificial structure that has a matrix and multiple fibers distributed and embedded in the matrix. Compared to other engineering materials, fiber reinforced composites may provide higher specific strength, stiffness and toughness that can be tailored for individual applications. The performance of fiber reinforced composites may be influenced by a variety of parameters. For example, the mechanical performance of fiber reinforced composites may depend on the strength and toughness of both fibers and matrix. The mechanical performance of fiber reinforced composites may also depend on the interfacial adhesion between fibers and matrix.

In fiber reinforced composites, interfacial adhesion between fibers and matrix may be improved by enhancing the chemical interaction at the fiber/matrix interface or by increasing the fiber surface area to provide a larger area over which load can be transferred. Oxidative surface treatments may add functional groups, remove weak outer layers of the fibers, and/or texture the fiber surface to increase the interfacial surface area. Nonoxidative surface treatments can involve the deposition of materials on the fiber surface, such as whiskers, to enhance load transfer and interfacial bonding.

### DESCRIPTION OF DRAWINGS

FIGS. 1a-d show SEM micrographs, taken at four length scales: (a) 120 μm, (b) 27.8 μm, (c) 3 μm, and (d) 500 nm, of exemplary carbon fibers with ZnO nanowires grown on the fiber surface.

FIGS. 2a-b show an example of single fiber tensile testing on bare carbon fibers and carbon fibers with ZnO nanowire grown on the fiber surface: (a) tensile stress and strain at failure for each fiber tested, and (b) tensile strength of each set of fibers tested.

FIGS. 3a-b show SEM micrographs, taken at two length scales: (a) 4 μtm and (b) 1 μm, of a cross section of an exemplary carbon fiber with ZnO nanowires grown on the fiber surface where the nanowires have been wetted with an epoxy resin, followed by curing.

FIGS. 4a-b show two examples of single fiber fragmentation testing on composite specimens with bare carbon fibers and with carbon fibers having ZnO nanowires grown the fiber surface where strain is plotted against number of fragments.

FIGS. 5a-f show an example of V-notch shear testing on lamina specimens with bare carbon fibers and with carbon fibers having ZnO nanowires grown on the fiber surface: (a) shear stress vs. strain, (b) G₁₃ shear modulus, (c) SEM micrograph, taken at a length scale of 100 μm, of a fracture surface of a specimen with bare carbon fibers, (d) SEM micrograph, taken at a length scale of 100 μm, of a fracture surface of a specimen with carbon fibers having ZnO nanowires grown on the fiber surface, (e) SEM micrograph, taken at a length scale of 5 μm, of a matrix surface after debonding of a carbon fiber with ZnO nanowires grown on the fiber surface, and (f) an enlarged view (length scale is 1 μm) of a matrix edge shown in (e).

FIGS. 6A-H show an example of ZnO nanowires grown on the surface of carbon fibers under different conditions. Growth time for A and B is 1 hour; growth time for C and D is 2.75 hours; growth time for E and F is 7.5 hours; and growth time for G and H is 15 hours. A, C, E, and G are produced in a control solution, while B, D, F, and H are produced in a similar solution with addition of polyethyleneimine. All primary scale bars are 5 μm and all inset scale bars are 2 μm.

FIG. 7 shows measured lengths of the ZnO nanowires shown in FIG. 6A-H.

FIG. 8 shows an example of single fiber fragmentation testing on composite specimens with carbon fibers having ZnO nanowires with different lengths grown on the fiber surface where nanowire length is plotted against number of cracks.

FIG. 9 schematically shows an exemplary functionalization of aramid fiber.

FIG. 10 shows SEM micrographs of an exemplary carboxylic acid functionalized aramid fiber with ZnO nanowires grown on the fiber surface. Upper inset shows close up of the ZnO nanowires. Lower inset shows ZnO nanowires falling off of an unfunctionalized aramid fiber.

FIG. 11 shows an example of single fiber tensile testing on bare aramid fibers, bare aramid fibers with ZnO nanowires grown on the fiber surface, functionalized aramid fibers, functionalized aramid fibers deposited with a seed layer and functionalized aramid fibers with ZnO nanowires grown on the fiber surface.

FIG. 12 shows an example of short shear beam testing on laminate samples with as-received aramid fabrics and with functionalized aramid fabrics with ZnO nanowires grown on the fabric surface.

### SUMMARY

This document discloses implementations of systems and techniques for enhancing the fiber/matrix interfacial strength of fiber reinforced composites with nanowire interphase while substantially maintaining the in-plane strength of the composites. The fiber reinforced composites can be fabricated using a low-temperature, solution-based growth of nanowires on the surface of the reinforcing fibers. The nanowires may increase the fiber surface area for bonding and penetrate into the matrix to improve load transfer. As such, the growth of the nanowires on the fiber surface can lead to no significant change in the fiber strength, while substantially increasing the interfacial shear strength and lamina shear strength and modulus.

In one aspect, a composite can include a matrix and multiple fibers embedded in the matrix where each fiber may have nanowires grown on at least a portion of an external surface of the fiber. The tensile strength of the fiber having the nanowires can be at least about 90% of the tensile strength of the fiber without the nanowires.

In various embodiments, an interface between the matrix and the fiber having the nanowires can have a strength that may be at least about 100% higher than an interface between the matrix and the fiber without the nanowires. The composite can have a shear strength that may be at least about 30% higher than a composite having fibers without nanowires. The composite can have a shear modulus that may be at least about 30% higher than a composite having fibers without nanowires. The nanowires can be formed by depositing a seed layer on at least a portion of the external surface of the fiber and growing the nanowires from the seed layer in a solution at a temperature less than about 100° C. where the solution may include an additive that can inhibit radial growth of the nanowires but allow longitudinal growth. The nanowires can be ZnO nanowires that may be formed by dissolving zinc acetate hydrate in a solvent to form a suspension of ZnO nanoparticles, coating a seed layer of ZnO nanoparticles on at least a portion of the external surface of the fiber using the suspension, and immersing the coated fiber in a solution of zinc nitrate hydrate, optionally in the presence of hexamethylenetetramine, ammonia, or a chemical that can generate basic conditions, to grow the ZnO nanowires from the seed layer at a temperature between about 65° C. and about 95° C. The ZnO nanowires can have an average length of about 1 μm to about 1.5 μm. The nanowires can have an aspect ratio greater than about 10. The fiber can be treated to create one or more functional groups on the external surface to enhance bonding between the fiber and the nanowires. The fiber can be a carbon fiber. The fiber can also be an aramid fiber where the external surface of the aramid fiber may be treated with a base solution to create a carboxylate group and a primary amine on the external surface, followed by an ion exchange with an acid solution to substantially remove carboxylate salt from the external surface.

In another aspect, a composite can include a polymer matrix and multiple carbon fibers embedded in the polymer matrix where each carbon fiber may have ZnO nanowires grown on at least a portion of an external surface of the carbon fiber. The tensile strength of the carbon fiber having the ZnO nanowires can be at least about 90% of the tensile strength of the carbon fiber without the ZnO nanowires. An interface between the polymer matrix and the carbon fiber having the ZnO nanowires can have a strength that is at least about 100% higher than an interface between the polymer matrix and the carbon fiber without the ZnO nanowires.

In some embodiments, the composite can have a shear strength and a shear modulus that may be both at least about 30% higher than a composite having carbon fibers without ZnO nanowires. In some embodiments, the ZnO nanowires can be formed by dissolving zinc acetate hydrate in a solvent to form a suspension of ZnO nanoparticles, coating a seed layer of ZnO nanoparticles on at least a portion of the external surface of the fiber using the suspension, and immersing the coated fiber in a solution of zinc nitrate hydrate, optionally in the presence of hexamethylenetetramine, ammonia, or a chemical that can generate basic conditions, to grow the ZnO nanowires from the seed layer at a temperature between about 65° C. and about 95° C.

In a further aspect, a composite can include a polymer matrix and multiple aramid fibers embedded in the polymer matrix where each aramid fiber may have ZnO nanowires grown on at least a portion of an external surface of the aramid fiber. The tensile strength of the aramid fiber can be at least about 90% of the tensile strength of the aramid fiber without the ZnO nanowires. The composite can have a shear strength that may be at least about 5% higher than a composite having aramid fibers without ZnO nanowires.

In some embodiments, the aramid fiber can be functionalized by treating the external surface of the aramid fiber with a base solution to create a carboxylate group and a primary amine on the external surface, followed by an ion exchange with an acid solution to substantially remove carboxylate salt from the external surface. In some embodiments, the ZnO nanowires can be formed by dissolving zinc acetate hydrate in a solvent to form a suspension of ZnO nanoparticles, coating a seed layer of ZnO nanoparticles on at least a portion of the external surface of the fiber using the suspension, and immersing the coated fiber in a solution of zinc nitrate hydrate, optionally in the presence of hexamethylenetetramine, ammonia, or a chemical that can generate basic conditions, to grow the ZnO nanowires from the seed layer at a temperature between about 65° C. and about 95° C.

These and other aspects and their embodiments and implementations are described in greater detail in the drawings, the description and the claims.

### DETAILED DESCRIPTION

This document relates to techniques and systems for improving the fiber/matrix interface of fiber reinforced composites with nanowire interphase while substantially maintaining the strength of the reinforcing fibers. In some embodiments, the tensile strength of fibers having nanowires grown on the fiber surface can be at least about 90% or about 95% of the tensile strength of bare fibers. In some embodiments, the tensile strength of fibers having nanowires grown on the fiber surface can be substantially the same as bare fibers (e.g., the difference in strength between the fibers with nanowires and the bare fibers is within about ±1 or 2% relative to the strength of the bare fibers). In some embodiments, the tensile strength of fibers having nanowires grown on the fiber surface can be higher than bare fibers. The fibers can be any reinforcing fibers suitable for use in composite materials. Representative examples of such fibers can include glass fibers (e.g., E-glass fibers, S-glass fibers and C-glass fibers), carbon fibers (e.g., rayon-based carbon fibers, PAN-based carbon fibers and pitch-based carbon fibers), aramid fibers (e.g., Kevlar fibers), boron fibers, polyolefin fibers (e.g., ultra high molecular weight polyethylene fibers), silicon carbide fibers, high-silica and high quartz fibers, alumina-based fibers and metal filaments. The fibers can be surface-treated to enhance the bonding between the fibers and the nanowires grown on the fiber surface. Suitable surface treatment can include oxidation treatments such as oxidative gas or dry oxidation, wet oxidation, and aqueous electrolytic or anodic oxidation. Suitable surface treatment can also include the use of coupling agents, wetting agents and/or sizes (sizings or coatings). Suitable surface treatment can further include the formation of functional surface groups such as acid and base surface oxides (e.g., carboxylic acid, hydroxyl or carboxyl groups, silanol groups or the like). The fiber reinforced composites can be fabricated using a variety of matrix materials including polymers, carbon, metals and ceramics. Representative examples of polymers suitable for use as matrix can include thermosets such as epoxies based on bisphenol A, aminophenols, diaminodiphenyl methane, triphenol methane or novolaks; bismaleimides; polyimides; ethynyl-terminated resins; unsaturated polyesters; vinyl ester resins; phenolic resins; and resol or novolak type resins; and thermoplastics such as polyolefins; vinyls; polyamides; polyacrylics; polyesters; and aromatic polyesters; poly(phenylene ether); polyphenylene sulfide; polysulfone; aromatic polyetherether ketone (PEEK); and polyimides such as ether-, ester- or amide-imides.

This document provides a low-temperature, solution-based technique for growing nanowires on fibers in tows, fabrics or the like. This nanowire growth technique can include coating a suspension of seed nanoparticles onto a fiber, followed by immersing the coated fiber in a growth solution to form nanowires on the surface of the fiber. The growth technique can be particularly suitable for growing nanowires on fibers such as carbon fibers and polymer fibers including aramid fibers and polyethylene fibers where nanowire growth at high temperatures may significantly degrade the strength of the fibers. The growth technique may be used to grow any suitable nanowires including nanowires of transition metal oxides such as ZnO, TiO₂ and SiO₂. As an example, ZnO nanowires can be grown on a carbon fiber or a functionalized aramid fiber by first forming ZnO nanoparticles in a ethanol or methanol solution of zinc acetate dihydrate, and then depositing a seed layer of ZnO nanoparticles on the surface of the carbon fiber or functionalized aramid fiber, followed by growing ZnO nanowires on the fiber surface in an aqueous solution of zinc nitrate hydrate, optionally in the presence of hexamethylenetetramine, ammonia or another chemical that is capable of generating basic conditions, at a temperature less than about 100° C. (e.g., between about 65° C. to about 95° C.).

This document also provides a fiber that has nanowires grown on the fiber surface using the low-temperature, solution-based growth technique. This document further provides a fiber reinforced composite with nanowire interphase where nanowires are grown using the low-temperature, solution-based growth technique. The nanowires may have high surface area for improved bonding between the fibers and matrix and may also penetrate into the matrix so as provide localized matrix reinforcement to enhance load transfer. As such, the composite provided herein that has a nanowire interphase can exhibit increased strength and toughness. In some embodiments, the interfacial strength of composites reinforced with fibers having nanowires grown on the fiber surface can increase by at least about 500%, about 300%, about 100%, about 50%, about 20%, about 10% or any value therebetween (e.g., about 400%, about 200%, about 80%, about 30%, about 15%), as compared to composites reinforced with bare fibers. In some embodiments, the shear strength of composites reinforced with fibers having nanowires grown on the fiber surface can increase by at least about 50%, about 30%, about 10%, about 5% or any value therebetween (e.g., about 40%, about 20%, about 9%, about 6%), as compared to composites reinforced with bare fibers. In some embodiments, the shear modulus of composites reinforced with fibers having nanowires grown on the fiber surface can increase by at least about 50%, about 30%, about 10%, about 5% or any value therebetween (e.g., about 40%, about 20%, about 9%, about 6%), as compared to composites reinforced with bare fibers.

In some implementations, ZnO nanowires can be grown on carbon fibers using a solution-based growth technique. For example, a suspension of ZnO nanoparticles can be prepared by forming ZnO nanoparticles by dissolving zinc acetate dihydrate (0.01 M) in methanol (125 mL) under stirring at about 60° C. A 0.03 M solution of KOH (65 mL) in methanol can then be added, followed by stirring for 2 hours at about 60° C. A suspension of ZnO nanoparticles can also be prepared by forming ZnO nanoparticles by dissolving zinc acetate dihydrate (0.0125 M) in ethanol at 50° C. under stirring. After cooling to room temperature, the solution can be diluted to a concentration of 0.0014 M. A 0.02 M NaOH ethanol solution can be prepared at 60° C. and after cooling be diluted to a concentration of 0.0057 M. The two solutions can then be mixed at a growth temperature of 55° C. at a volume ratio of 18:7. The resulting suspension of ZnO nanoparticles can then be coated onto carbon fibers through dip coating, spin coating, self-assembly, electrophoretic deposition or the like. For untreated carbon fibers, ZnO nanoparticles can be coated onto the fibers by dip coating, after which the coated fibers can be annealed at 150° C. for 5 or 10 minutes to enhance the adhesion between the fibers and the ZnO nanoparticles.

ZnO nanowires can then be grown using a hydrothermal method. For example, carbon fibers seeded with ZnO nanoparticles can be immersed in an aqueous solution of zinc nitrate hydrate (0.025 M) and hexamethylenetetramine (HMTA) (0.025 M) at temperatures between 80-90° C. The growth process can be performed in a glass beaker with the solution temperature maintained at 90° C. for 2 or 4 hours on a hot plate. The carbon fibers can then be rinsed with deionized water and dried at 100° C. after removal from the solution. In some embodiments, an electric field may be used to reduce the nanowire growth time by more than 35 times.

The hydrolysis reaction of zinc salt such as zinc nitrate hydrate may lead to the formation of one-dimensional ZnO crystals under a wide variety of conditions. For example, the formation of ZnO nanowires (aspect ratio greater than about 10) can occur at pH conditions between 9-12 without the use of additives, while ZnO nanowires can form with pH values from 5-9 in the presence of amines such as hexamethylenetetramine (HMTA). Variation of the solution's molar concentration, pH, temperature and exposure time may allow for control over the length, diameter and spatial density of the ZnO nanowires. This process can also grow ZnO nanowires on other substrates such as tows, fabrics or the like that can be used to reinforce composite materials. The process described herein uses ZnO nanoparticles as the seeds for nanowire growth, but many other catalysts such as gold may also be used to grow ZnO nanowires. ZnO nanowires can also be grown by thermal deposition of zinc acetate.

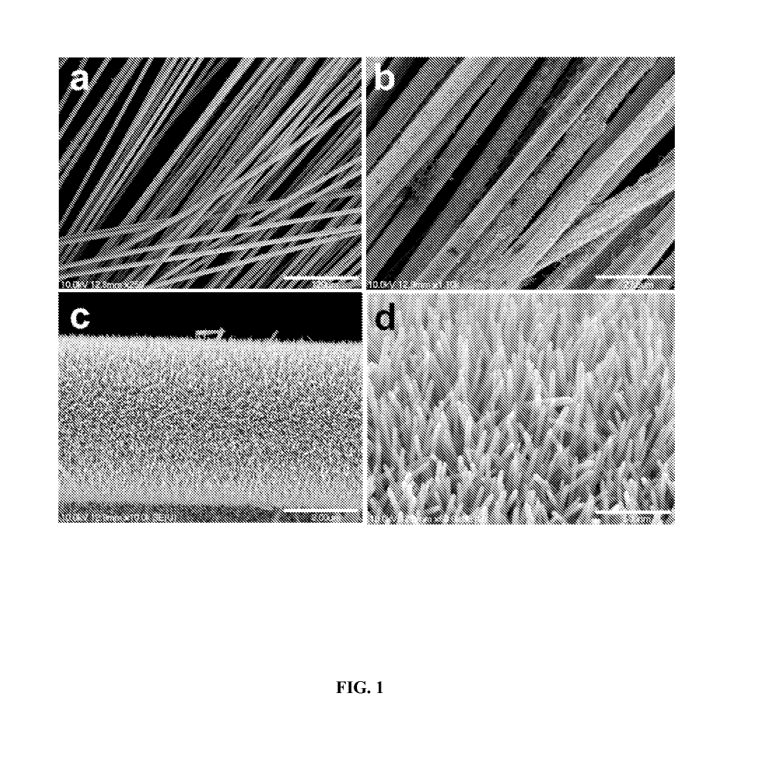

As an example, FIGS. 1a-1d show SEM images of ZnO nanowires grown on a tow of IM7 carbon fibers. In this example, the process described herein can lead to relatively uniform growth of ZnO nanowires along carbon fibers. The nanowires can be about 10 nm to about 50 nm in diameter and about 50 nm to about 10 μm in length. The process can provide nanowires with aspect ratios up to about 50, while higher aspect ratios (e.g., greater than about 125) can be generated by introducing a molecule that inhibits radial growth of the nanowires but allows axial growth.

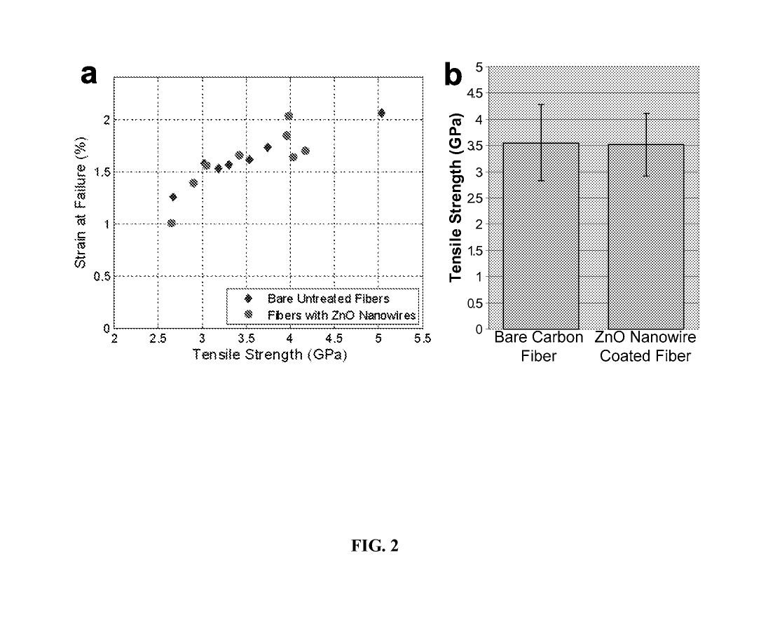

In some implementations, single fiber tensile testing can be performed to measure the strength of a single fiber. For example, a single fiber can be bonded to a paper mat such that the fiber can span a cutout region to facilitate handling. The paper mat bonded with the fiber can then be mounted onto a load frame at which point the paper mat can be cut to allow load to be transferred to the fiber. As an example, single fiber tensile testing was performed on two sets of fibers: one is bare IM7 carbon fibers used as-received and another is IM7 carbon fibers with ZnO nanowires grown on the fiber surface. For each set, eight fibers were tested. FIG. 2a shows stress and strain at failure for each fiber tested, and FIG. 2b shows tensile strength for each fiber set tested. In this example, the growth of ZnO nanowires on the carbon fibers induced no statistically significant change in the tensile strength of the fibers. Since the strength of fibers may determine the in-plane strength of fiber reinforced composites, composites reinforced with carbon fibers having ZnO nanowires grown on the fiber surface can have an in-plane strength that is comparable to composites reinforced with bare carbon fibers.

In some implementations, single fiber fragmentation testing can be performed to measure the interfacial shear strength between a single fiber and a matrix. For example, a single fiber can be embedded in a dog bone shaped specimen of a polymer matrix, followed by loading the specimen embedded with the fiber while observing the specimen using an optical microscope. When a tensile load is applied to the specimen, stress can be transferred to the fiber through shear stresses at the fiber/matrix interface. As the applied load increases, the fiber can reach its tensile strength and break. Since the broken fiber may continue to carry load as the polymer specimen is further strained, the fiber can continue to fracture into shorter fragments until a saturation point is reached. At this saturation point, the surface area of each fiber fragment can no longer transfer sufficient shear load to the fiber to reach the tensile strength and induce further breaks. At constant fiber diameter and fiber strength, shorter fragment lengths may imply a stronger fiber/matrix interface.

In some implementations, single fiber composite specimens can be fabricated by suspending a single carbon fiber across a silicon mold that is infiltrated with a composites grade epoxy (Epon 862 resin and Epikure 9553 or Epon 863 resin and 9554 hardener, both available from Hexion Specialty Chemicals, Houston, Tex. and blended at a resin to hardener weight ratio of 100:16.9). The carbon fiber can be pre-strained during curing by suspending a 3.73 g weight from fiber during curing.

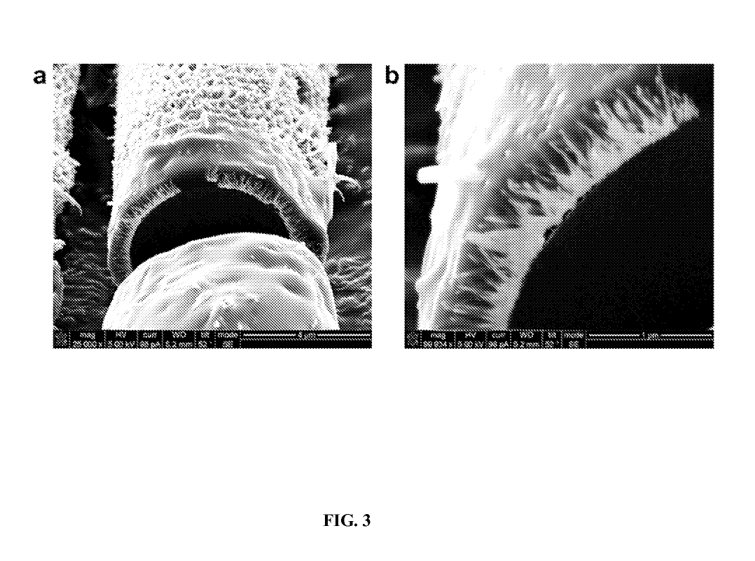

During the fabrication of the composite specimens, a small amount of the composites grade epoxy can be applied to a carbon fiber with ZnO nanowires grown on the fiber surface, followed by curing. The carbon fiber, ZnO nanowires and epoxy coating can then be milled away using Nova 200 NanoLab UHR FEG-SEM/FIB so that the cross section of the fiber can be viewed. As an example, FIGS. 3a-b show a cross section of a carbon fiber with epoxy wetted ZnO nanowires. In this example, the epoxy resin well wet the fiber surface having nanowires.

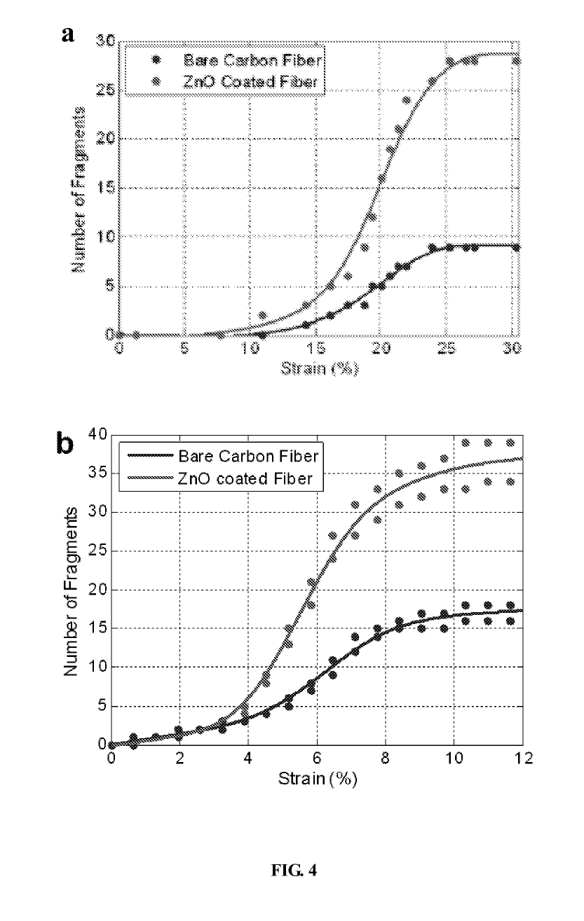

Once the composite specimens are cured, the specimens can be tested using a microtensile testing system. The testing system may be designed such that the specimens can be observed through an optical microscope under polarized light while stress and strain are applied on the specimens. As such, the number of fiber fragments can be measured under increasing strain so as to identify the saturation point. As an example, fragmentation testing was performed on two sets of composite specimens: one fabricated with bare carbon fibers and another fabricated with carbon fibers having ZnO nanowires grown on the fiber surface. FIGS. 4a-b respectively show a plot of strain vs. number of fragments over a 16 mm sample for each set of specimens. In this example, composite specimens of carbon fibers with ZnO nanowires grown on the fiber surface have a significantly increased density of fractured fiber fragments, as compared to composite specimens of bare carbon fibers. This suggests that growth of ZnO nanowires on fibers can substantially improve the fiber/matrix interface strength of fiber reinforced composites. In FIG. 4a where the epoxy matrix is formed from Epon 862 resin and Epikure 9553, the interfacial shear strength can be calculated to increase from about 5.51 MPa for composite specimens with bare carbon fibers to about 19.28 MPa for composite specimens with carbon fibers having ZnO nanowires grown on the fiber surface, or by about 350%. In FIG. 4b where the epoxy matrix is formed from Epon 863 resin and 9554 hardener, the interfacial shear strength can be calculated to increase from about 15.87 MPa for composite specimens with bare carbon fibers to about 33.87 MPa for composite specimens with carbon fibers having ZnO nanowires grown on the fiber surface, or by about 110%.

In some implementations, V-notch shear testing (ASTM 5379) can be performed to measure the shear modulus and strength of a lamina which is a single layer of composite without separate plies of reinforcement. For example, composite laminas can be fabricated from bare carbon fibers and from carbon fibers with ZnO nanowires grown on the fiber surface. The matrix material can be Epon 862 resin and 9553 hardener that are blended at a resin to hardener weight ratio of 100:16.9. The laminas can be cast in an aluminum mold with 1 MPa applied via external pressure and vacuum bagging. The laminas can then be cured at room temperature for one hour, followed by one hour at 100° C. and one hour at 160° C. The laminas can have a volume fraction of about 50% as measured by ASTM D3171.

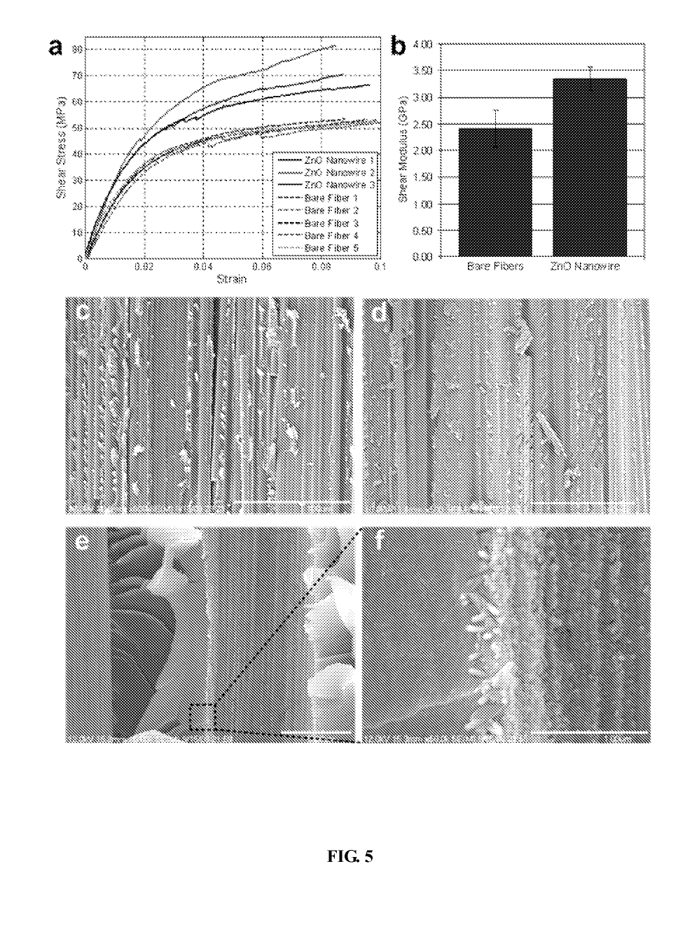

As an example, V-notch testing was performed on two sets of specimens: one of five laminas fabricated with bare carbon fibers and another of three laminas fabricated with carbon fibers having ZnO nanowires grown on the fiber surface. FIG. 5a shows shear stress-strain response of each specimen tested, and FIG. 5b shows shear modulus (G₁₃) of each specimen set tested. In this example, laminas of carbon fibers with ZnO nanowires grown on the fiber surface have significantly increased shear strength and shear modulus, compared to laminas of bare carbon fibers. More specifically, the average shear strength increases from about 52.9 MPa for laminas with bare carbon fibers to about 72.95 MPa for laminas with carbon fibers having ZnO nanowire grown on the fiber surface or by about 37%, while the average shear modulus increases from about 2.41 GPa for laminas with bare carbon fibers to about 3.34 GPa for laminas with carbon fibers having ZnO nanowires grown on the fiber surface or by about 39%.

FIG. 5c shows a shear fracture surface of a lamina of bare carbon fibers that failed under V-notch testing. In this example, the failure of the lamina appears to be dominated by fiber debonding or adhesive failure of the fiber/matrix interface. FIG. 5d shows a shear fracture surface of a lamina of carbon fibers having ZnO nanowires grown on the fiber surface that failed under V-notch testing. In this example, the failure of the lamina appears to be dominated by cohesive failure of the matrix.

FIG. 5e shows a failed surface of a V-notch specimen after debonding of a carbon fiber with ZnO nanowires grown on the fiber surface, and FIG. 5f shows a magnified view of a region in FIG. 5e where the carbon fiber was separated from the ZnO nanowires. In this example, the lamina appears to fail at the interface between the ZnO nanowires and the carbon fiber while the ZnO nanowires appear to remain well bonded to the matrix after the failure.

In some implementations, the aspect ratios of ZnO nanowires may be changed through variation of growth time and temperature as well as addition of polymer surface additive such as polyethyleneimine (PEI) to growth solution. For example, ZnO nanoparticles can be prepared in an ethanol suspension by forming a 0.0125 M solution of zinc acetate dihydrate (Reagent Grade, Sigma) and a 0.02 M solution of sodium hydroxide (ACS Grade, EMD Chemicals). 80 mL aliquots of the zinc acetate/ethanol solution and the sodium hydroxide/ethanol solution can then be diluted with 640 mL and 200 mL of pure ethanol, respectively. The two diluted solutions can be heated to 55° C., mixed under stirring and maintained at a growth temperature of 55° C. for 30 minutes. The seed suspension can then be quenched in ice water down to room temperature.

Unsized IM7 carbon fibers (Hexcel, Stamford CT) can be cleaned in ethanol and acetone. The fibers can then be dip coated in the ZnO nanoparticle suspension and annealed for 10 minutes at 150° C. three times. ZnO nanowires can be grown from the deposited seed layer on the carbon fibers by immersing the fibers in a preheated aqueous solution of 0.025 M zinc nitrate hexahydrate (99%, Alfa Aesar), 0.025 M hexamethylenetetramine (99%, Alfa Aesar) and 0.005 M branched PEI (Sigma, MW about 25,000) at 90° C. in water bath. The solution can be replaced every 2.5 hours and the fibers can be washed with deionized water each time the solution is changed.

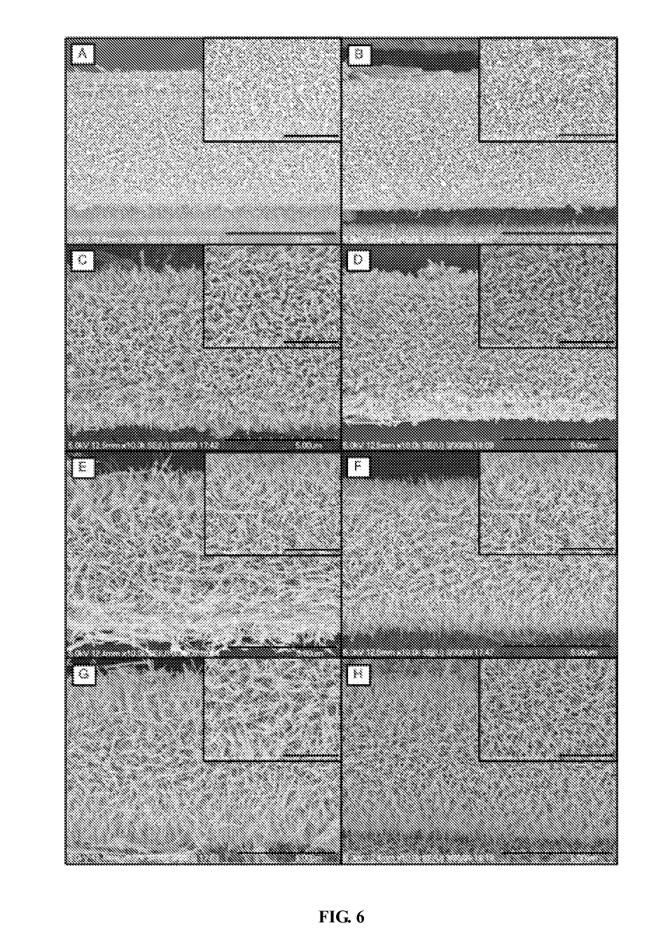

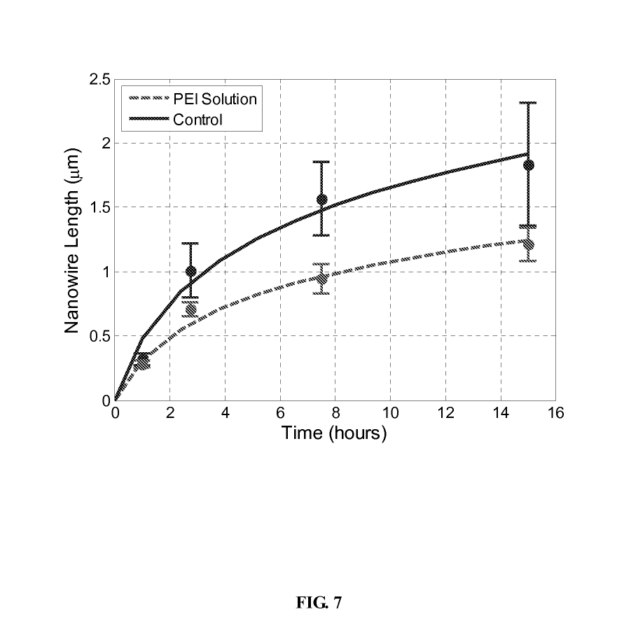

As an example, FIG. 6A-H show ZnO nanowires grown on carbon fibers for different times and with or without PEI. The ZnO nanowires shown in FIGS. 6A-B were grown for 1 hour; the ZnO nanowires shown in FIGS. 6C-D were grown for 2.75 hours; the ZnO nanowires shown in FIGS. E-F were grown for 7.5 hours; and the ZnO nanowires shown in FIGS. G-H were grown for 15 hours. The ZnO nanowires shown in FIGS. 6A, 6C, 6E and 6G were grown in a control solution, while the ZnO nanowires shown in FIGS. 6B, 6D, 6F and 6H were grown in a similar solution with PEI. FIG. 7 shows measured lengths of the ZnO nanowires shown in FIGS. 6A-H as a function of growth time and growth solution. The nanowire lengths were measured in 11 random spots for each growth condition and the corresponding averages with confidence levels were plotted. A logarithmic growth model was fit with R² values as at least 0.95 for both control solution and solution with PEI. In this example, the average length of ZnO nanowires increases with growth time. PEI appears to reduce longitudinal growth rate of ZnO nanowires. PEI also appears to maintain better alignment of ZnO nanowires and to reduce longitudinal or randomly oriented nanowires.

In some implementations, single fiber fragmentation testing can be performed to measure the interface strength of composite specimens fabricated with single carbon fibers having ZnO nanowires with different lengths grown on the fiber surface. For example, composite specimens can be prepared by placing single carbon fibers having ZnO nanowires with different lengths into silicone rubber (3120 RTV, Dow Corning Corp, Midland Mich.) dog bone molds and filling the molds with Epon 862 (Hexion, Houston Tex.) and Epikure 9553 that are mixed in 100:16.9 parts by weight. The epoxy mixture can then be gelled for 90 minutes at 45° C. on a hotplate, followed by 1 hour in an oven at 100° C. and 1 hour at 160° C. The specimens can be polished to 2400 grit for testing in a microtensile system under polarized transmitted light. Strain can be incrementally applied and the fibers scanned for cracks. The fibers can be continually strained until the number of cracks saturates where no further cracking is observed with applied strain. Strain rate can be approximately 0.6%/min during straining and approximately 3 minutes can be given to count the number of cracks in a specimen.

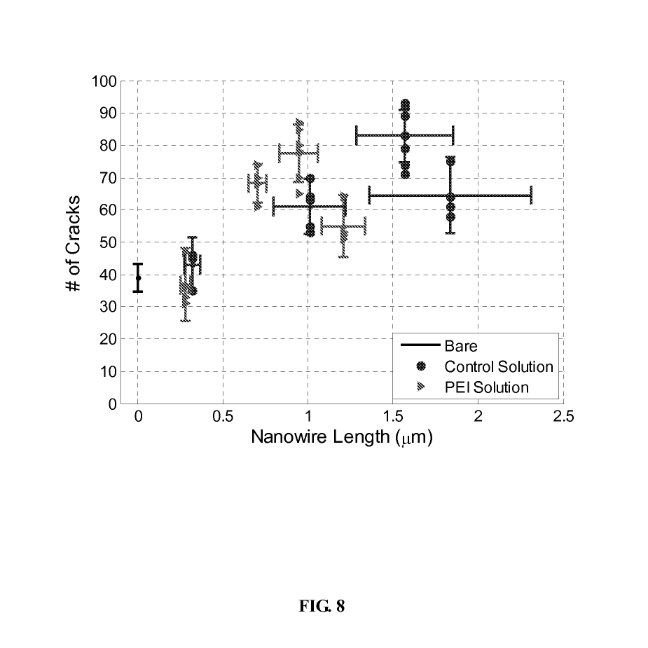

As an example, single fiber fragmentation testing was performed on composite specimens of carbon fibers having ZnO nanowires that were grown under the same growth conditions as the carbon fibers shown in FIGS. 6A-H. FIG. 8 shows number of cracks in each specimen tested as related to nanowire length. In this example, the number of cracks increases from about 39 to about 83 or by about 110%. A maximum appears to exist for both control solution and PEI solution at the second longest nanowire length.

In some implementations, ZnO nanowires can be grown on aramid fibers using a solution-based growth technique. For example, unidirectional aramid fibers (CST Sales, Tehachapi, Calif.) can be washed in two successive chloroform baths followed absolute ethanol to remove a manufacturer applied surface adhesive. The fibers can be dried for 30 minutes under vacuum at 80° C. and then rinsed in acetone and ethanol again to substantially remove further organic surface contaminants. A 10% aqueous NaOH solution can be prepared and allowed to cool to 23° C. The fibers can be functionalized by soaking in the NaOH solution for 20 minutes in an open beaker and then washed several times in deionized water. The fibers can then be dried for 60 minutes at 100° C. under vacuum. The functionalized fibers can be acid washed in a beaker of 33% HCl for 10 seconds and then rinsed several times in deionized water. The fibers can again be dried at 100° C. for 60 minutes under vacuum.

ZnO nanowires can then be grown using a hydrothermal method. For example, seeds can be synthesized by first creating a 0.02 M solution of NaOH in ethanol and a 0.0125 M solution of zinc acetate dihydrate in ethanol. 80 mL aliquots of the sodium hydroxide solution and the zinc acetate solution can then be diluted with 200 mL and 640 mL of pure ethanol, respectively. The two solutions can be heated to 55° C. separately and then mixed and stirred for 30 minutes. The seeds can then be quenched in ice water to room temperature to slow the growth process. The cleaned, functionalized, dry fibers can be dipped into the seeding solution, dried at room temperature and then annealed at 150° C. to deposit a seed layer for the ZnO nanowires. This can be repeated twice more and then the fibers can be placed into the ZnO growth solution. The growth solution can be 0.025 M Zn(NO₃)₂.6H₂O and 0.025 M hexamethylenetetramine (Alfa Aesar, Ward Hill, Mass.) solution in deionized water at 90° C. The fibers can be placed in the preheated growth solution for 4 hours in a controlled temperature water bath and then washed several times in deionized water. The fibers can then be dried at 100° C. under vacuum.

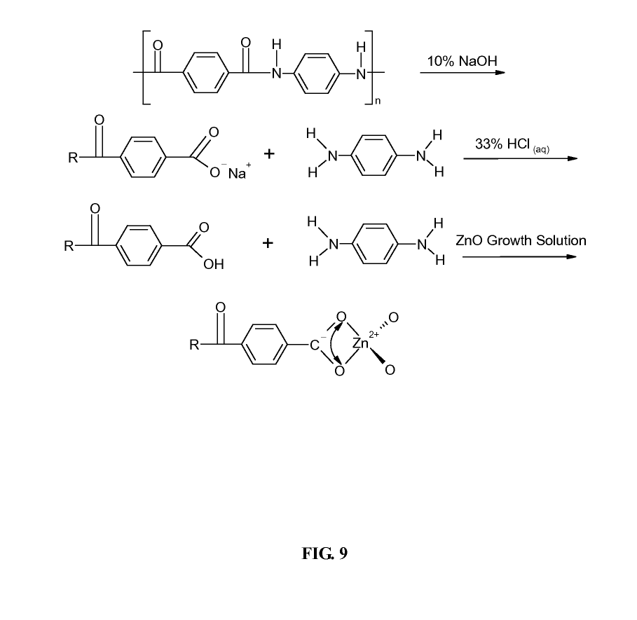

FIG. 9 shows the scheme of above fiber functionalization. The scheme first splits the amide linkage of the aramid fiber backbone chain to create a carboxylate group and a primary amine. Sodium ions are then removed with a 33% HCl solution ion exchange so that ZnO nanowires can attach to the functional groups created on the fiber surface.

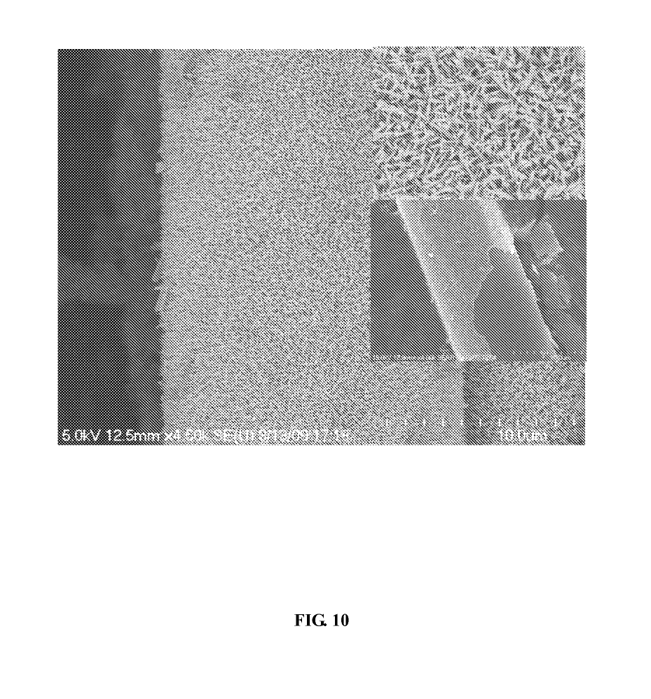

FIG. 10 shows an example of ZnO nanowires grown on a functionalized aramid fiber. In this example, the ZnO nanowires are relatively uniform in length and diameter. A typical nanowire can be about 50 nm in diameter and about 500 nm in length. The as-received aramid fibers appear to exhibit adhesive failure at the nanowire/fiber interface due to inert surface of the fibers.

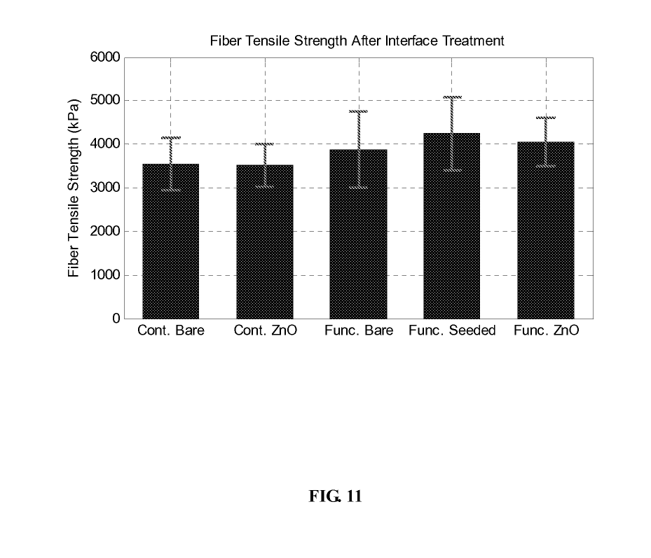

In some implementations, single fiber tensile testing can be performed to compare the tensile strengths of different single fibers. For example, single fibers can be separated and placed onto a paper template to create tabs. The fibers can be attached to the tabs with epoxy and the gage length between epoxy dots measured as ˜153 mm. An MTS Sintech 5G electromechanical tensile testing system can be used with a crosshead displacement rate of 1 mm/min. Load can be measured with a 100 g load cell (Transducer Techniques, Temecula, Calif.) and displacement through a built-in crosshead position sensor. As an example, single fiber tensile testing was performed on five sets of aramid fibers: (1) bare aramid fibers, (2) bare aramid fibers with ZnO nanowires grown on the fiber surface, (3) functionalized aramid fibers, (4) functionalized aramid fibers deposited with a seed layer, and (5) functionalized aramid fibers with ZnO nanowires grown on the fiber surface. FIG. 11 shows tensile strength for each fiber set tested. In this example, functionalized aramid fibers with or without ZnO nanowires exhibit no reduction in fiber tensile strength.

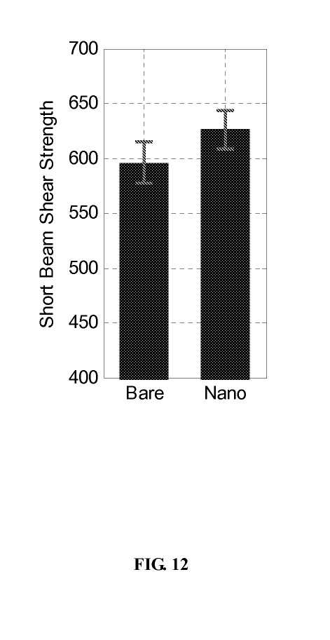

In some implementations, short beam shear testing can be performed to compare the interlaminar shear strengths of different laminate composites. For example, laminate samples can be fabricated from plain woven fabric swatches (CST Sales; the fabrics have no surface adhesive and thus the first chloroform washes described above may not be needed). Epon 862 epoxy resin and Epikure 9553 hardener (100:16.9 by weight) can be placed on each layer of fabric and then stacked. Two stacks of 10 plies of aramid weaves can be fabricated in one vacuum bag, one functionalized with nanowires and another as control. A nylon release ply can be used on the top and bottom of the laminate samples. The samples can be gelled under vacuum for 1 hour, then heated for 1 hour at 100° C. followed by 1 hour at 160° C. The samples can then be tested on a Sintech 5G tensile testing system in 3 point bending according to ASTM D2344. As an example, short beam shear testing was performed on two sets of laminate samples: one is fabricated with bare aramid fabrics and another is fabricated with functionalized aramid fabrics having ZnO nanowires grown on the fiber surface. FIG. 12 shows shear strength for each sample set tested. In this example, the growth of ZnO nanowires on functionalized fiber surface results in a statistically significant increase of about 5% in interlaminar shear strength. Longer ZnO nanowires with larger aspect ratios may further enhance the fiber/matrix interface of composites that are reinforced with aramid fibers coated having such nanowires grown on the fiber surface.

Tows or fabrics of fibers having nanowires grown on the fiber surface can be used to fabricate composite materials with increased strength and toughness. For example, tows or fabrics of carbon fibers or functionalized aramid fibers with ZnO nanowires grown on the fiber surface can be processed into composite materials using either thermoset or thermoplastic polymers, by conventional methods such as prepreg lay-up, towpreg, filament winding, resin transfer molding, fiber placement and the like. The composites with nanowire interface may be used in various applications ranging from aerospace to road and marine transport to general engineering. For example, the composites can be used to make engineering components such as bearings, gears, cams, fan blades and automobile bodies; components in building and construction industries; components in decorative elements in automotive, marine, general aviation interiors, general entertainment and musical instruments and after-market transportation products; and components in sporting goods such as golf clubs and bicycle frames. The composites with ZnO nanowire interface may utilize the semiconductive and piezoelectric properties of ZnO for multifunctional applications including gas sensors, solar cells, light emitting diodes, dynamic sensors and energy harvesting materials.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A composite, comprising:
a matrix; and
a plurality of fibers embedded in the matrix, each fiber having nanowires on at least a portion of an external surface of the fiber,
wherein the tensile strength of the fiber having the nanowires is at least about 90% of the tensile strength of the fiber without the nanowires.

2. The composite of claim 1, wherein an interface between the matrix and the fiber having the nanowires has a strength that is at least about 100% higher than an interface between the matrix and the fiber without the nanowires.

3. The composite of claim 1, wherein the composite has a shear strength that is at least about 30% higher than a composite having fibers without nanowires.

4. The composite of claim 1, wherein the composite has a shear modulus that is at least about 30% higher than a composite having fibers without nanowires.

5. The composite of claim 1, wherein the nanowires are formed by depositing a seed layer on at least a portion of the external surface of the fiber and growing the nanowires from the seed layer in a solution at a temperature less than about 100° C.

6. The composite of claim 5, wherein the solution comprises an additive capable of inhibiting radial growth of the nanowires but allowing longitudinal growth.

7. The composite of claim 1, wherein the nanowires comprise ZnO nanowires.

8. The composite of claim 7, wherein the ZnO nanowires are formed by dissolving zinc acetate hydrate in a solvent to form a suspension of ZnO nanoparticles, coating a seed layer of ZnO nanoparticles on at least a portion of the external surface of the fiber using the suspension, and immersing the coated fiber in a solution of zinc nitrate hydrate to grow the ZnO nanowires from the seed layer at a temperature between about 65° C. and about 95° C.

9. The composite of claim 8, wherein the ZnO nanowires have an average length of about 1 μm to about 1.5 μm.

10. The composite of claim 1, wherein the nanowires have an aspect ratio greater than about 10.

11. The composite of claim 1, wherein the fiber is treated to create one or more functional groups on the external surface to enhance bonding between the fiber and the nanowires.

12. The composite of claim 1, wherein the fiber comprises a carbon fiber or an aramid fiber.

13. The composite of claim 12, wherein the external surface of the aramid fiber is treated with a base solution to create a carboxylate group and a primary amine thereon, followed by an ion exchange with an acid solution to substantially remove carboxylate salt from the external surface.

14. The composite of claim 12, wherein the nanowires comprise ZnO nanowires.

15. The composite of claim 14, wherein the ZnO nanowires are formed by dissolving zinc acetate hydrate in a solvent to form a suspension of ZnO nanoparticles, coating a seed layer of ZnO nanoparticles on at least a portion of the external surface of the fiber using the suspension, and immersing the coated fiber in a solution of zinc nitrate hydrate to grow the ZnO nanowires from the seed layer at a temperature between about 65° C. and about 95° C.

16. (canceled)

17. A composite, comprising:
a polymer matrix; and
a plurality of carbon fibers embedded in the polymer matrix, each carbon fiber having ZnO nanowires on at least a portion of an external surface of the carbon fiber,
wherein the tensile strength of the carbon fiber having the ZnO nanowires is at least about 90% of the tensile strength of the carbon fiber without the ZnO nanowires, and
wherein an interface between the polymer matrix and the carbon fiber having the ZnO nanowires has a strength that is at least about 100% higher than an interface between the polymer matrix and the carbon fiber without the ZnO nanowires.

18. The composite of claim 17, wherein the composite has a shear strength and a shear modulus that are both at least about 30% higher than a composite having carbon fibers without ZnO nanowires.

19. (canceled)

20. A composite, comprising:
a polymer matrix; and
a plurality of aramid fibers embedded in the polymer matrix, each aramid fiber having ZnO nanowires on at least a portion of an external surface of the aramid fiber,
wherein the tensile strength of the aramid fiber is at least about 90% of the tensile strength of the aramid fiber without the ZnO nanowires, and
wherein the composite has a shear strength that is at least about 5% higher than a composite having aramid fibers without ZnO nanowires.

21. The composite of claim 20, wherein the aramid fiber is functionalized by treating the external surface of the aramid fiber with a base solution to create a carboxylate group and a primary amine thereon, followed by an ion exchange with an acid solution to substantially remove carboxylate salt from the external surface.

22. (canceled)

23. The composite of claim 8, wherein the coated fiber is immersed in a solution of zinc nitrate hydrate solution-in the presence of hexamethylenetetramine, ammonia, or a chemical capable of generating basic conditions.
